(19) United States
(12) Patent Application Publication
(10) Pub. No.: US 2017/0339479 A1
(43) Pub. Date: Nov. 23, 2017

(54) WIRELESS EAR-FITTING HEADPHONE SYSTEM HAVING DETACHABLE TETHER AND RELATED TECHNOLOGY

(71) Applicant: New Audio LLC, New York, NY (US)

(72) Inventor: Jonathan E. Levine, New York, NY (US)

(21) Appl. No.: 15/595,816

(22) Filed: May 15, 2017

Related U.S. Application Data
(60) Provisional application No. 62/337,803, filed on May 17, 2016.

(51) Int. Cl. H04R 1/10

(52) U.S. Cl. CPC H04R 1/105; H04R 1/1066; H04R 1/1016; H04R 1/1025; H04R 2420/07

(57) ABSTRACT

An ear-fitting headphone system in accordance with an embodiment of the present technology includes a first wireless earpiece, a second wireless earpiece, and a flexible tether. The first earpiece can include an earbud configured to be received within an ear canal of a first ear, and a housing configured to be received within a concha of the first ear. Similarly, the second earpiece can include an earbud configured to be received within an ear canal of a second ear, and a housing configured to be received within a concha of the second ear. The tether can be configured to detachably connect the first and second earpieces partially by detachably and interlockingly connecting to the first earpiece via a coupling at the housing of the first earpiece, and partially by detachably and interlockingly connecting to the second earpiece via a coupling at the housing of the second earpiece.

### CROSS-REFERENCE TO RELATED APPLICATION INCORPORATED BY REFERENCE

This application claims the benefit of U.S. Provisional Application No. 62/337,803, filed May 17, 2016, which is incorporated herein by reference in its entirety.

### TECHNICAL FIELD

The present technology is related to ear-fitting headphone systems.

### BACKGROUND

Headphone systems typically include two earpieces configured to be respectively worn at or near a user's ears. Each earpiece includes a speaker that converts an audio signal into sound. Because the sound is generated in close proximity to a user's ears, the sound is fully audible to the user while still being inaudible or minimally audible to others around the user. For this reason, headphone systems are well-suited for use in public settings. When in use, the earpieces of a headphone system can be independently supported by a user's ears or collectively supported, such as at opposite respective ends of a headpiece that bridges a user's head. In the former case, conventional features for independently supporting earpieces include ear hooks shaped to extend over a user's ear and earbuds shaped to extend into a user's ear canal. These and other features often increase the security of earpiece positioning at the expense of earpiece comfort and/or compactness.

Earpieces can be wired or wireless. Wired earpieces are earpieces that receive an audio signal and convert the audio signal into sound while being connected to one or more wires, such as wire connecting the earpieces to one another and wires connecting the earpieces to a source of the audio signal. Wireless earpieces are earpieces capable of receiving an audio signal and converting the audio signal into sound without being connected to any such wires. Instead of using wires, wireless earpieces may rely on Bluetooth or a similar wireless communication standard to receive an audio signal. Unlike wired earpieces, wireless earpieces often include a battery and an antenna. Wireless earpieces also typically include more internal circuitry than wired earpieces. Accordingly, wireless earpieces tend to be larger, heavier, and/or more expensive than wired earpieces. A wireless earpiece also may be easier to lose (e.g., after falling out of a user's ear or after being misplaced) than a wired earpiece. For these and/or other reasons, conventional approaches to securing wired earpieces may be inadequate or at least suboptimal in the context of wireless earpieces.

### BRIEF DESCRIPTION OF THE DRAWINGS

Many aspects of the present technology can be better understood with reference to the following drawings. The components in the drawings are not necessarily to scale. Instead, emphasis is placed on illustrating clearly the principles of the present technology. For ease of reference, throughout this disclosure identical reference numbers may be used to identify identical, similar, or analogous components or features of more than one embodiment of the present technology.

FIG. 1 is a top plan view of an ear-fitting headphone system in accordance with an embodiment of the present technology.

FIG. 2 is a top plan view of a first earpiece of the ear-fitting headphone system shown in FIG. 1.

FIG. 3 is a perspective view of the first earpiece of the ear-fitting headphone system shown in FIG. 1.

FIG. 4 is a perspective view of the first earpiece of the ear-fitting headphone system shown in FIG. 1 in use in an independent state, and a second earpiece of the ear-fitting headphone system shown in FIG. 1 also in use in an independent state.

FIG. 5 is a perspective view of the first earpiece of the ear-fitting headphone system shown in FIG. 1 in use in a tethered state, and the second earpiece of the ear-fitting headphone system shown in FIG. 1 also in use in a tethered state.

FIG. 6 is a perspective view of the first earpiece of the ear-fitting headphone system shown in FIG. 1 in use in a hooked state, and the second earpiece of the ear-fitting headphone system shown in FIG. 1 also in use in a hooked state.

FIG. 7 is a flow chart illustrating a method for operating the ear-fitting headphone system shown in FIG. 1 in accordance with an embodiment of the present technology.

### DETAILED DESCRIPTION

Ear-fitting headphone systems and related devices, systems, and methods in accordance with embodiments of the present technology can at least partially address one or more problems associated with conventional technologies whether or not such problems are stated herein. For example, ear-fitting headphone systems in accordance with at least some embodiments of the present technology include wireless earpieces and have innovative features for securing these wireless earpieces to a user's ears. An ear-fitting headphone system in accordance with a particular embodiment of the present technology includes a first wireless earpiece configured to be worn at a first one of a user's ears, and a second wireless earpiece configured to be worn at a second one of the user's ears. The first and second earpieces can be configured to conveniently transition between an independent state in which the earpieces are held in place via respective earbuds, and a tethered state in which the earpieces are held in place via respective earbuds and are tethered to one another. Furthermore, the first and second earpieces can be configured to transition between the independent state and a hooked state and/or between the tethered state and the hooked state. In the hooked state, the first and second earpieces can be hooked onto the user's ears.

In the independent, tethered, and hooked states, the first and second earpieces can be held in place with different respective levels of security and with different respective levels of comfort and compactness. For example, in the independent state, the first and second earpieces can be held in place with a relatively low level of security and with a relatively high level of comfort and compactness. The independent state can be well-suited for certain user preferences and/or use types. In the tethered and hooked states, the earpieces can be held in place with successively higher levels of security and with lower levels of comfort and compactness. The tethered and hooked states can be well-suited for other user preferences and/or use types. Thus, ear-fitting headphone systems in accordance with at least some embodiments of the present technology are more adaptable to user preferences and/or use types than conventional ear-fitting headphone systems. Embodiments of the present technology can have these and/or other advantages relative to conventional counterparts whether or not such advantages are described herein.

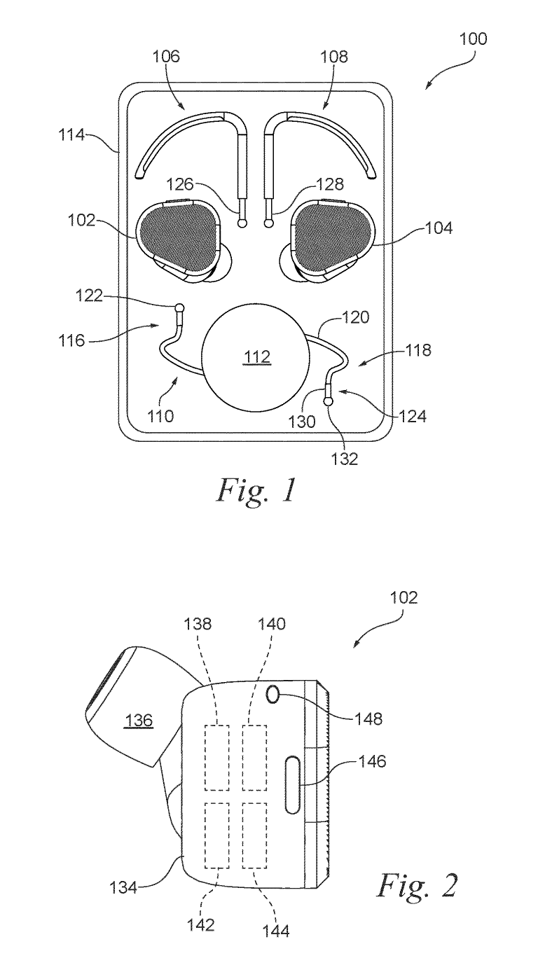

Specific details of ear-fitting headphone systems and related devices, systems, and methods in accordance with several embodiments of the present technology are described herein with reference to FIGS. 1-7. Although ear-fitting headphone systems and related devices, systems, and methods may be described herein primarily or entirely in the context of wireless, dual-earpiece headphone systems, other contexts in addition to those described herein are within the scope of the present technology. For example, suitable features of described wireless, dual-earpiece headphone systems can be implemented in the context of wired-earpiece headphone systems, and single-earpiece headphone systems, among other examples. Furthermore, it should understood, in general, that other systems, devices, and methods in addition to those disclosed herein are within the scope of the present technology. For example, systems, devices, and methods in accordance with embodiments of the present technology can have different and/or additional configurations, components, procedures, etc. than those disclosed herein. Moreover, a person of ordinary skill in the art will understand that systems, devices, and methods in accordance with embodiments of the present technology can be without one or more of the configurations, components, procedures, etc. disclosed herein without deviating from the present technology.

FIG. 1 is a top plan view of an ear-fitting headphone system 100 in accordance with an embodiment of the present technology. The headphone system 100 can include a first earpiece 102, a second earpiece 104, a first ear hook 106, a second ear hook 108, and a tether 110. The headphone system 100 can further include a spool 112 around which the tether 110 is wrapped when not in use. The headphone system 100 can also include a container 114 in which the first and second earpieces 102, 104, the first and second ear hooks 106, 108, the tether 110, and the spool 112 can be stored when not in use. The container 114 can include conformal indentations, dividers, and/or other features (not shown) that facilitate consistent positioning of the first and second earpieces 102, 104, the first and second ear hooks 106, 108, the tether 110, and the spool 112. In at least some embodiments, the headphone system 100 is a kit compact enough to fit in a user's pocket.

The tether 110 can be flexible and can include a first end portion 116, an opposite second end portion 118, and a flexible string 120 extending therebetween. The first end portion 116 of the tether 110 and the first ear hook 106 can be detachably (e.g., detachably and interlockingly) connectable to the first earpiece 102. Similarly, the second end portion 118 of the tether 110 and the second ear hook 108 can be detachably (e.g., detachably and interlockingly) connectable to the second earpiece 104. In the illustrated embodiment, the first end portion 116 of the tether 110 and the first ear hook 106 are interchangeably connectable to the first earpiece 102. For example, the first earpiece 102 can be configured to be connected to one or the other of the first end portion 116 of the tether 110 and the first ear hook 106 at any given time. Similarly, in the illustrated embodiment, the second end portion 118 of the tether 110 and the second ear hook 108 are interchangeably connectable to the second earpiece 104. For example, the second earpiece 104 can be configured to be connected to one or the other of the second end portion 118 of the tether 110 and the second ear hook 108 at any given time. In other embodiments, the first end portion 116 of the tether 110 and the first ear hook 106 can be connectable to the first earpiece 102 at the same time. In addition or alternatively, the second end portion 118 of the tether 110 and the second ear hook 108 can be connectable to the second earpiece 104 at the same time.

With reference again to FIG. 1, the tether 110 and the first and second ear hooks 106, 108 can include features that cooperate with corresponding features of the first and second earpieces 102, 104 to form releasable interlocking connections or other suitable releasable connections. In the illustrated embodiment, these features are plugs configured to detachably and interlockingly connect to ports of the first and second earpieces 102, 104. For example, the tether 110 can include first and second plugs 122, 124 at its first and second end portions 116, 118, respectively. Similarly, the first and second ear hooks 106, 108 can include third and fourth plugs 126, 128, respectively. Each of the first, second, third, and fourth plugs 122, 124, 126, 128 (collectively referred to as plugs 122-128) can include a shaft 130 (one labeled in FIG. 1) having a lateral protrusion 132 (one labeled in FIG. 1). The lateral protrusions 132 can be rounded distal end portions of the corresponding shafts 130. In at least some cases, the lateral protrusions 132 are made of rubber or a similar resilient material. The first and second earpieces 102, 104 can include recesses (not shown) shaped to receive the lateral protrusion 132, and associated restricted passages (not shown) through which the lateral protrusions 132 must pass before reaching the recesses. In other embodiments, the tether 110 and the first and second ear hooks 106, 108 can connect to the first and second earpieces 102, 104 in another suitable manner.

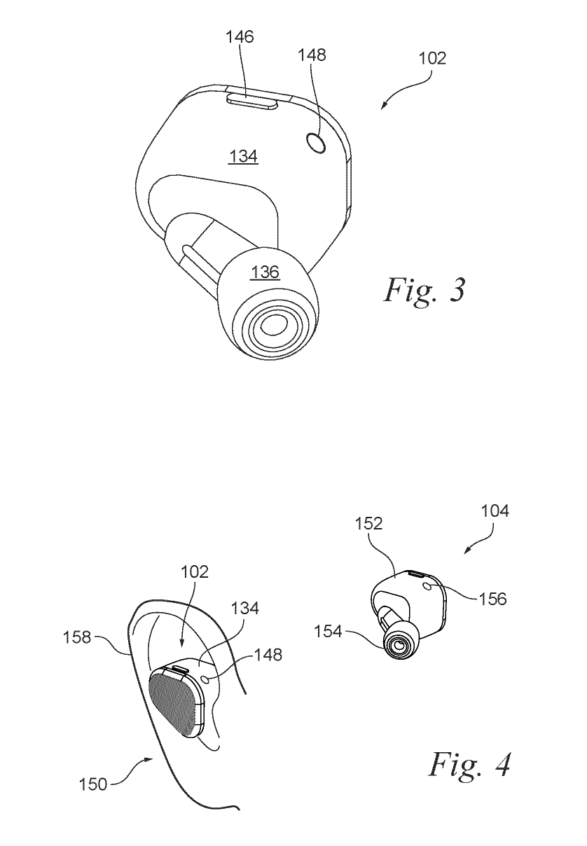

FIGS. 2 and 3 are, respectively, a top plan view and a perspective view of the first earpiece 102. Features of the first earpiece 102 will now be described with the understanding that the same or similar features can be present in the second earpiece 104. With reference to FIGS. 1-3 together, the first earpiece 102 can be configured to be worn at a user's ear (not shown), and can include a first housing 134 configured to be received within a concha of the user's ear, and a first earbud 136 configured to be received within an ear canal of the user's ear. The first earpiece 102 can be wireless and can include corresponding electronics. For example, the first earpiece 102 can include an antenna 138, processing circuitry 140, and a battery 142 (each shown schematically) disposed within the first housing 134. The first earpiece 102 can further include a speaker 144 (shown schematically) also disposed within the first housing 134. At an exterior of the first housing 134, the first earpiece 102 can include a button 146 operable to turn the first earpiece 102 on or off, to change the volume of sound from the speaker 144, and/or to cause another change in operation of the first earpiece 102.

At the first housing 134, the first earpiece 102 can include a first port 148 through which the first ear hook 106 and the tether 110 (e.g., via its first end portion 116) are interchangeably connectable to the first earpiece 102. When the first earpiece 102 is operably positioned at a user's ear with the first earbud 136 and the first housing 134 received, respectively, within the ear canal and the concha of the user's ear, the first port 148 can be at an upper anterior portion of the first housing 134. As described in further detail below, this positioning of the first port 148 can be useful to facilitate placement of the tether 110 and the first ear hook 106 relative to the user's head. The lateral protrusions 132 of the plugs 122-128 can be configured to be interlockingly received within the first port 148. When the lateral protrusion 132 of a given one of the plugs 122-128 is interlockingly received within the first port 148, the corresponding shaft 130 can be at least partially inset into the first port 148. The shafts 130 can be relatively stiff. For example, the shafts 130 of the first and second plugs 122, 124 can be stiffer than the string 120. This can be useful, for example, to reduce or eliminate unintentional detachment of the plugs 122-128 in response to force acting in a direction other than a direction axially aligned with the shafts 130.

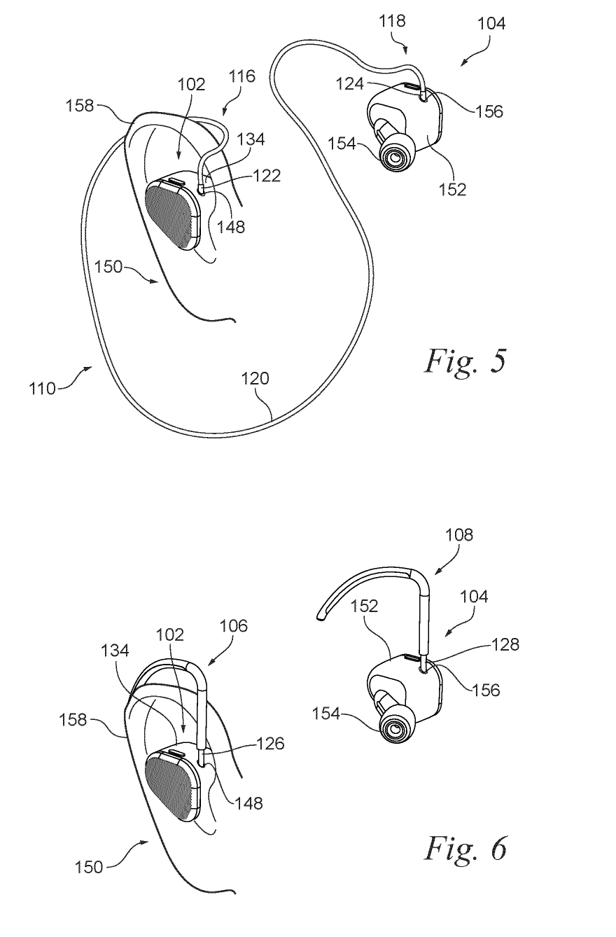

FIGS. 4, 5 and 6 are perspective views of the first and second earpieces 102, 104 in use in an independent state, a tethered state, and a hooked state, respectively. A user's ear 150 associated with the first earpiece 102 is also shown in FIGS. 4-6. For clarity of illustration, the user's ear associated with the second earpiece 104 and the user's head are not shown in FIGS. 4-6. With reference to FIGS. 1-6 together, the second earpiece 104 can include a second housing 152, a second earbud 154, and a second port 156 corresponding, respectively, to the first housing 134, the first earbud 136, and the first port 148 of the first earpiece 102. In the independent state shown in FIG. 4, the first and second earpieces 102 can be held in place primarily by snug fitting of the first and second earbuds 136, 154 within corresponding ear canals (not shown). In the tethered state shown in FIG. 5, the first and second earpieces 102 can be held in place in this manner and be detachably tethered to one another via the tether 110. In the hooked state shown in FIG. 6, the first and second earpieces 102 can be held in place partially by snug fitting of the first and second earbuds 136, 154 within the corresponding ear canals and partially by hooking of the first and second ear hooks 106, 108 around the user's ears.

The independent, tethered, and hooked states can be well-suited for use of the headphone system 100 in different settings. For example, the independent state may be well-suited for use in home and office settings when accidental detachment of the first and second earpieces 102 is both unlikely and of little consequence (e.g., because a detached one of the first and second earpieces 102, 104 can be easily retrieved and replaced). The tethered state may be well-suited for mild activity (e.g., walking) in public settings when accidental detachment of the first and second earpieces 102 is unlikely, but would be of greater consequence (e.g., because a detached one of the first and second earpieces 102, 104 would not be easy to retrieve and replace). Finally, the hooked state may be well-suited for strenuous activity (e.g., jogging) in public settings when accidental detachment of the first and second earpieces 102 would be likely in the absence of the first and second ear hooks 106, 108. In addition or alternatively, the independent, tethered, and hooked states can accommodate the preferences of particular users. For example, users who find ear hooks to be uncomfortable may choose to use the first and second earpieces 102 in the tethered state even when engaging in strenuous activity in public settings.

As shown in FIG. 5, the first plug 122 and the first port 148 can form a coupling at an upper anterior portion of the first housing 134 when the first earbud 136 and the first housing 134 are received, respectively, within the ear canal and the concha of the ear 150. The tether 110 can extend upwardly from the first port 148 and then rearwardly between a helix 158 of the ear 150 and the user's head. Similarly, the second plug 124 and the second port 156 can form a coupling at an at an upper anterior portion of the second housing 152 when the second earbud 154 and the second housing 152 are received, respectively, within the ear canal and the concha of the user's other ear. The tether 110 can extend upwardly from the second port 156 and then rearwardly between a helix (not shown) of the user's other ear and the user's head. This positioning of the tether 110 can be useful, for example, because any unintentional pulling of the tether 110 is likely to be downward and, thus, not in a direction likely to detach the tether 110 from the first and second earpieces 102, 104. Furthermore, if one of the first and second earbuds 136, 154 becomes detached from the corresponding ear canal, the tether 110 may retain the corresponding one of the first and second earpieces 102, 104 close to the corresponding ear for ready replacement.

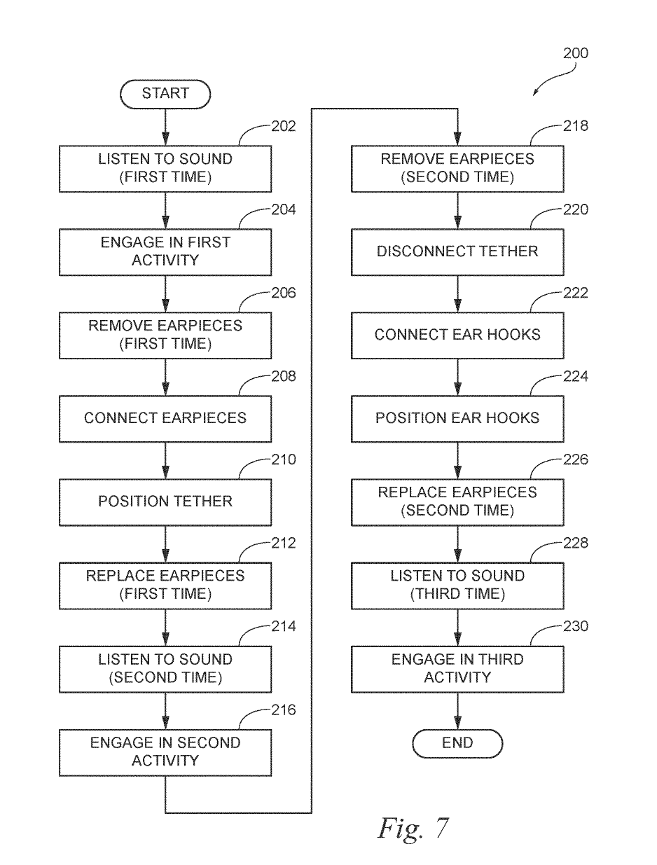

FIG. 7 is a flow chart illustrating a method 200 for operating the headphone system 100 in accordance with an embodiment of the present technology. With reference to FIGS. 1-7, the method 200 can include listening to sound a first time (block 202) via the first and second earpieces 102, 104 while the first earpiece 102 is in the independent state at a first ear, and while the second earpiece 104 is in the independent state at an opposite second ear. The method 200 can further include engaging in a first activity (block 204) while listening to sound the first time. The first activity can be one that is relatively unlikely to cause displacement of the first and second earpieces 102, 104 from their corresponding operable positions at the first and second ears. After listening to sound the first time and engaging in the first activity, the method 200 can include removing the first and second earpieces 102, 104 from the first and second ears a first time (block 206). Next, the method 200 can include connecting the first and second earpieces 102, 104 to one another via the tether 110 (block 208). For example, the first and second plugs 122, 124 can be inserted into the first and second ports 148, 156, respectively. In at least some cases, this interlocks the first plug 122 and the first port 148, and interlocks the second plug 124 and the second port 156.

While the first and second earpieces 102, 104 are connected via the tether 110, the method 200 can include positioning the tether 110 relative to the first and second ears (block 210). For example, the method 200 can include positioning a first portion of the tether 110 at a superior portion of a postauricular space adjacent to the first ear, and positioning a second portion of the tether 110 at a superior portion of a postauricular space adjacent to the second ear. The method 200 can then include replacing the first and second earpieces 102, 104 at the first and second ears, respectively, a first time (block 212). Replacing the first and second earpieces 102, 104 can include positioning the first and second earbuds 136, 154 within ear canals of the first and second ears, respectively, and positioning the first and second housings 134, 152 within conchas of the first and second ears, respectively. Next, the method 200 can include listening to sound a second time (block 214) via the first and second earpieces 102, 104 while the first earpiece 102 is in the tethered state at the first ear, and while the second earpiece 104 is in the tethered state at the second ear. The method 200 can further include engaging in a second activity (block 216) while listening to sound the second time. The second activity can be one that is more likely than the first activity to cause displacement of the first and second earpieces 102, 104 from their corresponding operable positions at the first and second ears.

After listening to sound the second time and engaging in the second activity, the method 200 can include removing the first and second earpieces 102, 104 from the first and second ears a second time (block 218). Next, the method 200 can include disconnecting the tether 110 (block 220). For example, the first and second plugs 122, 124 can be withdrawn from the first and second ports 148, 156, respectively. In at least some cases, this includes pulling the shafts 130 of the first and second plugs 122, 124 such that the lateral protrusions 132 of the shafts 130 deform and uncouple from interlocking engagement with corresponding recesses within the first and second ports 148, 156, respectively. After the tether 110 has been disconnected, the method 200 can include connecting the first and second ear hooks 106, 108 to the first and second earpieces 102, 104, respectively (block 222), such as by inserting the third and fourth plugs 126, 128 into the first and second ports 148, 156, respectively. In at least some cases, this interlocks the third plug 126 and the first port 148, and interlocks the fourth plug 128 and the second port 156.

Once the first and second ear hooks 106, 108 have been connected to the first and second earpieces 102, 104, respectively, the method 200 can include positioning the first and second ear hooks 106, 108 relative to the first and second ears (block 224). For example, the method 200 can include positioning a portion of the first ear hook 106 at the superior portion of the postauricular space adjacent to the first ear, and positioning a portion of the second ear hook 108 at the superior portion of the postauricular space adjacent to the second ear. The method 200 can then include replacing the first and second earpieces 102, 104 at the first and second ears, respectively, a second time (block 226). Next, the method 200 can include listening to sound a third time (block 228) via the first and second earpieces 102, 104 while the first earpiece 102 is in the hooked state at the first ear, and while the second earpiece 104 is in the hooked state at the second ear. The method 200 can further include engaging in a third activity (block 230) while listening to sound the third time. The third activity can be one that is more likely than the first activity and/or more likely that the second activity to cause displacement of the first and second earpieces 102, 104 from their corresponding operable positions at the first and second ears.

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown and/or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may have been disclosed in the context of those embodiments, other embodiments may also exhibit such advantages, and not all embodiments need necessarily exhibit such advantages or other advantages disclosed herein to fall within the scope of the present technology.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the terms “comprising” and the like may be used herein to mean including at least the recited feature(s) such that any greater number of the same feature(s) and/or one or more additional types of features are not precluded. Directional terms, such as “upper,” “lower,” “front,” “back,” “vertical,” and “horizontal,” may be used herein to express and clarify the relationship between various elements. It should be understood that such terms do not denote absolute orientation. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments of the present technology.

I/We claim:

1. An ear-fitting headphone system, comprising:
a first wireless earpiece configured to be worn at a first one of a user's ears, wherein the first earpiece includes—
an earbud configured to be received within an ear canal of the first ear, and
a housing configured to be received within a concha of the first ear;
a second wireless earpiece configured to be worn at a second one of the user's ears,
wherein the second earpiece includes—
an earbud configured to be received within an ear canal of the second ear, and
a housing configured to be received within a concha of the second ear; and
a flexible tether configured to detachably connect the first and second earpieces partially by detachably and interlockingly connecting to the first earpiece via a coupling at the housing of the first earpiece, and partially by detachably and interlockingly connecting to the second earpiece via a coupling at the housing of the second earpiece.

2. The ear-fitting headphone system of claim 1 wherein:
the coupling at the housing of the first earpiece is at an upper anterior portion of the housing of the first earpiece when the earbud and the housing of the first earpiece are received, respectively, within the ear canal and the concha of the first ear; and
the coupling at the housing of the second earpiece is at an upper anterior portion of the housing of the second earpiece when the earbud and the housing of the second earpiece are received, respectively, within the ear canal and the concha of the second ear.

3. The ear-fitting headphone system of claim 1, further comprising:
a first ear hook; and
a second ear hook,
wherein—
the tether and the first ear hook are interchangeably connectable to the first earpiece, and
the tether and the second ear hook are interchangeably connectable to the second earpiece.

4. The ear-fitting headphone system of claim 1 wherein:
the first earpiece includes a battery disposed within the housing of the first earpiece; and
the second earpiece includes a battery disposed within the housing of the second earpiece.

5. The ear-fitting headphone system of claim 1 wherein:
the first earpiece includes a first port;
the second earpiece includes a second port; and
the tether includes—
a first plug configured to detachably and interlockingly connect to the first port to form the coupling at the housing of the first earpiece,
a second plug configured to detachably and interlockingly connect to the second port to form the coupling at the housing of the second earpiece, and
a flexible string extending between the first and second plugs.

6. The ear-fitting headphone system of claim 5 wherein:
the first plug is at a first end portion of the tether;
the second plug is at an opposite second end portion of the tether;
the first plug includes a first shaft having a lateral protrusion;
the second plug includes a second shaft having a lateral protrusion;
the lateral protrusions of the first and second shafts are configured to be interlockingly received within the first and second ports, respectively; and
the first and second shafts are stiffer than the string.

7. The ear-fitting headphone system of claim 5, further comprising:
a first ear hook including a third plug, wherein the third plug is configured to detachably and interlockingly connect to the first port; and
a second ear hook including a fourth plug, wherein the fourth plug is configured to detachably and interlockingly connect to the second port.

8. The ear-fitting headphone system of claim 5 wherein:
the tether extends upwardly from the first port when the first plug and the first port are detachably and interlockingly connected and when the earbud and the housing of the first earpiece are received, respectively, within the ear canal and the concha of the first ear; and
the tether extends upwardly from the second port when the second plug and the second port are detachably and interlockingly connected and when the earbud and the housing of the second earpiece are received, respectively, within the ear canal and the concha of the second ear.

9. The ear-fitting headphone system of claim 5 wherein:
the first port is at an upper anterior portion of the housing of the first earpiece when the earbud and the housing of the first earpiece are received, respectively, within the ear canal and the concha of the first ear; and
the second port is at an upper anterior portion of the housing of the second earpiece when the earbud and the housing of the second earpiece are received, respectively, within the ear canal and the concha of the second ear.

10. An ear-fitting headphone system, comprising:
a first wireless earpiece configured to be worn at a first one of a user's ears;
a second wireless earpiece configured to be worn at a second one of the user's ears;
a flexible tether having a first end portion and an opposite second end portion;
a first ear hook; and
a second ear hook,
wherein—
the first end portion of the tether and the first ear hook are interchangeably connectable to the first earpiece, and
the second end portion of the tether and the second ear hook are interchangeably connectable to the second earpiece.

11. The ear-fitting headphone system of claim 10 wherein:
the first end portion of the tether and the first ear hook are detachably and interlockingly connectable to the first earpiece; and
the second end portion of the tether and the second ear hook are detachably and interlockingly connectable to the second earpiece.

12. The ear-fitting headphone system of claim 10 wherein:
the first earpiece includes a first port through which the first ear hook and the first end portion of the tether are interchangeably connectable to the first earpiece; and
the second earpiece includes a second port through which the second ear hook and the second end portion of the tether are interchangeably connectable to the second earpiece.

13. The ear-fitting headphone system of claim 12 wherein:
the tether includes—
a first plug configured to detachably connect to the first port,
a second plug configured to detachably connect to the second port, and
a flexible string extending between the first and second plugs;
the first ear hook includes a third plug configured to detachably connect to the first port; and
the second ear hook includes a fourth plug configured to detachably connect to the second port.

14. The ear-fitting headphone system of claim 13 wherein:
the first plug includes a first shaft having a lateral protrusion;
the second plug includes a second shaft having a lateral protrusion;
the lateral protrusions of the first and second shafts are configured to be interlockingly received within the first and second ports, respectively; and
the first and second shafts are stiffer than the string.

15. A method for operating an ear-fitting headphone system, the method comprising:
listening to sound a first time via a first earpiece of the ear-fitting headphone system and via a second earpiece of the ear-fitting headphone system while the first earpiece is in an independent state at a first ear, and while the second earpiece is in an independent state at a second ear;
removing the first and second earpieces from the first and second ears, respectively, after listening to sound the first time;
connecting the first and second earpieces to one another via a flexible tether after removing the first and second earpieces;
positioning a first portion of the tether at a superior portion of a postauricular space adjacent to the first ear;
positioning a second portion of the tether at a superior portion of a postauricular space adjacent to the second ear;
replacing the first and second earpieces at the first and second ears, respectively; and
listening to sound a second time via the first and second earpieces while the first earpiece is in a tethered state at the first ear, and while the second earpiece is in a tethered state at the second ear.

16. The method of claim 15 wherein:
replacing the first and second earpieces includes—
positioning an earbud of the first earpiece within an ear canal of the first ear,
positioning a housing of the first earpiece within a concha of the first ear,
positioning an earbud of the second earpiece within an ear canal of the second ear, and
positioning a housing of the second earpiece within a concha of the second ear; and
connecting the first and second earpieces to one another includes—
inserting a first plug of the tether into a first port of the first earpiece, the first port being at the housing of the first earpiece, and
inserting a second plug of the tether into a second port of the second earpiece, the second port being at the housing of the second earpiece.

17. The method of claim 16 wherein:
inserting the first plug into the first port includes interlockingly inserting the first plug into the first port; and
inserting the second plug into the second port includes interlockingly inserting the second plug into the second port.

18. The method of claim 15 wherein removing the first and second earpieces includes removing the first and second earpieces a first time, wherein replacing the first and second earpieces includes replacing the first and second earpieces a first time, and wherein the method further comprises:
removing the first and second earpieces a second time from the first and second ears, respectively, after listening to sound the second time;
disconnecting the tether from the first and second earpieces after removing the first and second earpieces the second time;
connecting a first ear hook to the first earpiece;
connecting a second ear hook to the second earpiece;
positioning a portion of the first ear hook at the superior portion of the postauricular space adjacent to the first ear;
positioning a portion of the second ear hook at the superior portion of the postauricular space adjacent to the second ear;
replacing the first and second earpieces a second time at the first and second ears, respectively; and
listening to sound a third time via the first and second earpieces while the first earpiece is in a hooked state at the first ear, and while the second earpiece is in a hooked state at the second ear.

19. The method of claim 18 wherein:
replacing the first and second earpieces the first time includes—
positioning an earbud of the first earpiece within an ear canal of the first ear,
positioning a housing of the first earpiece within a concha of the first ear,
positioning an earbud of the second earpiece within an ear canal of the second ear, and
positioning a housing of the second earpiece within a concha of the second ear;
connecting the first and second earpieces to one another includes—
inserting a first plug of the tether into a first port of the first earpiece, the first port being at the housing of the first earpiece, and
inserting a second plug of the tether into a second port of the second earpiece, the second port being at the housing of the second earpiece;
connecting the first ear hook to the first earpiece includes inserting a third plug of the first ear hook into the first port; and
connecting the second ear hook to the second earpiece includes inserting a fourth plug of the fourth ear hook into the second port.

20. The method of claim 18, further comprising:
engaging in a first physical activity while listening to sound the first time;
engaging in a second physical activity while listening to sound the second time; and
engaging in a third physical activity while listening to sound the third time,
wherein the first, second, and third physical activities are successively more prone to causing displacement of the first and second earpieces from corresponding operable positions at the first and second ears.
